(19) United States
(12) Patent Application Publication
(10) Pub. No.: US 2013/0226628 A1
(43) Pub. Date: Aug. 29, 2013

(54) EVENT-CENTRIC MATCHING AND SOCIAL NETWORKING SERVICES

(71) Applicants: John D. Scher, Aliso Viego, CA (US); Richard Knecht, Newport Beach, CA (US); Jeffrey A. Monroe, Fallbrook, CA (US); Paul C. Otis, Foothill Ranch, CA (US); Gary J. Millea, Huntington Beach, CA (US)

(72) Inventors: John D. Scher, Aliso Viego, CA (US); Richard Knecht, Newport Beach, CA (US); Jeffrey A. Monroe, Fallbrook, CA (US); Paul C. Otis, Foothill Ranch, CA (US); Gary J. Millea, Huntington Beach, CA (US)

(21) Appl. No.: 13/405,070

(22) Filed: Feb. 24, 2012

(51) Int. Cl. G06Q 10/02; G06F 17/30

(52) U.S. Cl. 705/5; 707/769

(57) ABSTRACT

Methods for matching a first user of an online service site to a second user for jointly attending an event of mutual interest are disclosed. A first event query is received from the first user. In response, a first event listing including the event of mutual interest is transmitted to the first computer system. A selection of this event is received, together with an admission matching proposal therefor. A corresponding admission availability entry is added to an event announcement page, which is subsequently transmitted to a second user. If the second user so desires and so selects, then an admission matching offer is received by the online service site.

### CROSS-REFERENCE TO RELATED APPLICATIONS

### STATEMENT RE: FEDERALLY SPONSORED RESEARCH/DEVELOPMENT

Not Applicable

### BACKGROUND

1. Technical Field

The present disclosure relates generally to online services for dating, friendship and other social networking, and more particularly to an event-centric matching and social networking service.

2. Related Art

Well beyond its simple information sharing roots, the Internet and the World Wide Web (the Web) in particular are now utilized for all manners of communication and interpersonal interaction. There are countless interactive web-based applications that offer various services such as online shopping, banking, social networking, as well as the traditional information retrieval, with new services being introduced regularly. Access to the Internet is nearly ubiquitous throughout daily life, as computing devices such as home computers, workplace computers, mobile/laptop computers, and mobile telephone devices are never far, and there are many ways to connect, including wired broadband, WiFi, mobile data and so forth. Given the near universal access to the Internet, many efforts have been directed to improving ways in which people connect with others locally, as well as across long geographic distances.

One such application is online dating, and with an estimated 110 million singles in the country, there is a substantial need and market for dating and matchmaking services. Commonly, users create an account and a profile, for which basic autobiographical information is provided, such as name, age, gender, and sexual orientation. Photographs of the user can be uploaded and saved to the profile, along with a more detailed narrative that may describe the user's personality, personal preferences, and the like. In its most simple form, a user may post a profile and wait until another user browses that profile and initiates a communication. The user may, in turn, view the profile of the other user to decide whether to continue with the dialogue or not. If sufficient interest is generated between the two users, with the communications modality of the online dating service or with conventional e-mail or instant messaging, the users may plan to meet in person to continue the courtship process.

With more sophisticated services, the users may each be required to answer a series of detailed questionnaires that assess personality types and other quantifiable characteristics, in addition to providing the standard profile information noted above. Based on the personality assessments, compatible matches may be suggested by the online dating service. Typically, with such services that build extensive personality profiles, compatibility evaluations go beyond the basic matching of similar backgrounds, similar interests, similar personalities, and so forth, and rely upon complex algorithms that utilize various factors to predict ideal candidates for long-term relationships.

Most online dating sites ultimately revolve around text message-based conversations types from the comforts of the user's home on a computer, mobile phone, smart phone, or from some other location similarly isolated from the other user. If the interest between two users grows beyond that stage, a few conversations may occur over the phone, but much of the initial courtship period requires extensive online communications that are impersonal at best. Much time and effort may be wasted during this time, as the hours spent sending and responding to electronic messages may yield the same compatibility assessment between two users as what could be determined in just five minutes of meeting in person. Further, the conversations may not be meaningful because one user's attention may be divided between multiple prospects. As will be appreciated by those having skill in the art, love, compatibility, and happiness in a relationship are not necessarily quantifiable for processing via a computerized algorithm. Finding a sense of compatibility between two people is entirely dependent on emotion and feelings that cannot be easily described or understood, and the best way to determine compatibility is simply through interaction. Although dinner and movie dates certainly have their place, the participants on a date may have more fun and thus more likely to connect while attending major entertainment events. This is more so where the interest in the event is shared; indeed, many individuals may be uninterested in pursuing relationships with potential companions who do not share the same entertainment interests.

The appeal in sharing the fun of jointly attending an entertainment event of mutual interest is not limited to the dating scenario. Those already involved in romantic relationships (or married) may have a desire to connect with others with similar entertainment values, possibly because their romantic partner may have absolutely no interest in that particular event. Furthermore, those who have recently moved to a new location and have not yet had the opportunity to establish friendships without any romantic aspect may also have an interest in connecting with others during a fun-filled entertainment event.

The selling of admissions or tickets to events on the secondary market outside the control of authorized agents is common, and various online services exist to meet its needs. Most commonly, these are local and regional classified sites where other products and services are also advertised. The tickets are bought and sold as any other item for sale, and facilitate nothing more than arm's length transactions.

Accordingly, there is a need in the art for an event-centric matching service. Such a service may also be desirable outside of the dating context, for matching friends, groups of friends or potential associates, and enthusiasts of a particular entertainer, type of entertainment, and so forth.

### BRIEF SUMMARY

In accordance with various embodiments of the present disclosure, a social networking service that includes elements of online dating centered on event ticketing is contemplated. After establishing a profile, a database of potential partner candidates is searched for shared entertainment interests. If there is an initial interest, candidates may apply to attend events together. These steps ensure that matched users have common entertainment interests, and the likelihood of a successful friendship, encounter or date is increased because of the shared experience of attending. The service may also be utilized to match for friendship prospects and other social or business relationships rather than for dating.

One embodiment may be a method for matching a first user of an online service site to a second user for jointly attending an event of mutual interest is contemplated. The method may include receiving a first event query from the first user. There may also be a step of transmitting a first event listing to a first computer system of the first user from the online service site. This first event listing may include a plurality of selectable events including the event of mutual interest, and may be transmitted to the first computer system in response to and in conformance with the first event query. The method may continue with receiving a selection of the event of mutual interest from the first user. Accompanying the selection may be a general admission matching proposal therefor. There may be a step of adding an admission availability entry to an event announcement page that may be associated with the selected event of mutual interest. The admission availability entry may correspond to the general admission matching proposal. Furthermore, the method may include transmitting the admission availability entry from the online service site to a second computer system of the second user of the online service. There may additionally be a step of receiving an admission matching offer for the event of mutual interest from the second computer system. This may be provided in response to the general admission matching proposal for the event of mutual interest.

Another embodiment may also be a method for matching a first user of an online service site to a second user for jointly attending an event of mutual interest. The method may include one user in a “Join Me” role where they offer up a ticket to someone needing a ticket, while another user is in a “Take Me” role where they ask someone to take them to an entertainment based event based on a similar interest. The method may include receiving a first event query from the first user. There may also be a step of transmitting a first event listing from the online service site to a first computer system of the first user. This may be in response to and in conformance with the first event query. The first event listing may include a plurality of selectable events including the event of mutual interest. Additionally, the method may include receiving a selection of the event of mutual interest as well as an admission matching request from the first user. Thereafter, there may be a step of adding an admission request entry to an event announcement page that is associated with the selected event of mutual interest. The admission request entry may correspond to the admission matching request. There may also be a step of transmitting the admission request entry from the online service site to a second computer system of the second user of the online service. The method may include receiving an admission matching offer for the event of mutual interest from the second computer system. This may be in response to the admission matching request for the event.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one networked computing environment in which the methods of the present disclosure may be implemented including client computer systems and a matching service site;

FIGS. 2A-2G are screen shots of various subsections of an exemplary user account and profile modification interface on the matching service site;

FIGS. 3A-3B are screen shots of an exemplary profile page;

FIG. 4 is a flowchart showing the steps of one embodiment of a method for event-centric matching;

FIG. 5 is a screen shot of an exemplary initial event search page;

FIG. 6 is a diagram showing the elements of an event listing;

FIG. 7 is a screen shot of an exemplary event query results page returned in response to a first event query;

FIG. 8 is a screen shot of an exemplary event detail page invoked from a link in the event query results page;

FIG. 9 is a screen shot of an exemplary invitation input page displayed after activating an inviter or “Join Me” button;

FIG. 10 is a screen shot of an exemplary general announcement page;

FIG. 11 is a screen shot showing a transmitted admission availability entry;

FIG. 12 is a screen shot showing an exemplary connection request page;

FIG. 13 is a screen shot of an exemplary admission purchasing page;

FIG. 14 is a flowchart showing the steps of another embodiment of a method for event-centric matching in accordance with the present disclosure;

FIG. 15 is a screen shot of an exemplary request input page displayed after activating an invitee or “Take Me” button; and

FIG. 16 is a screen shot of an exemplary request response page displayed after activating the inviter or “Join Me” button following the addition of an admission request entry.

Common reference numerals are used throughout the drawings and the detailed description to indicate the same elements.

### DETAILED DESCRIPTION

Event-centric matching is disclosed. The methods in accordance with various embodiments of the present disclosure may be implemented as executable software instructions stored on non-transitory data storage media. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

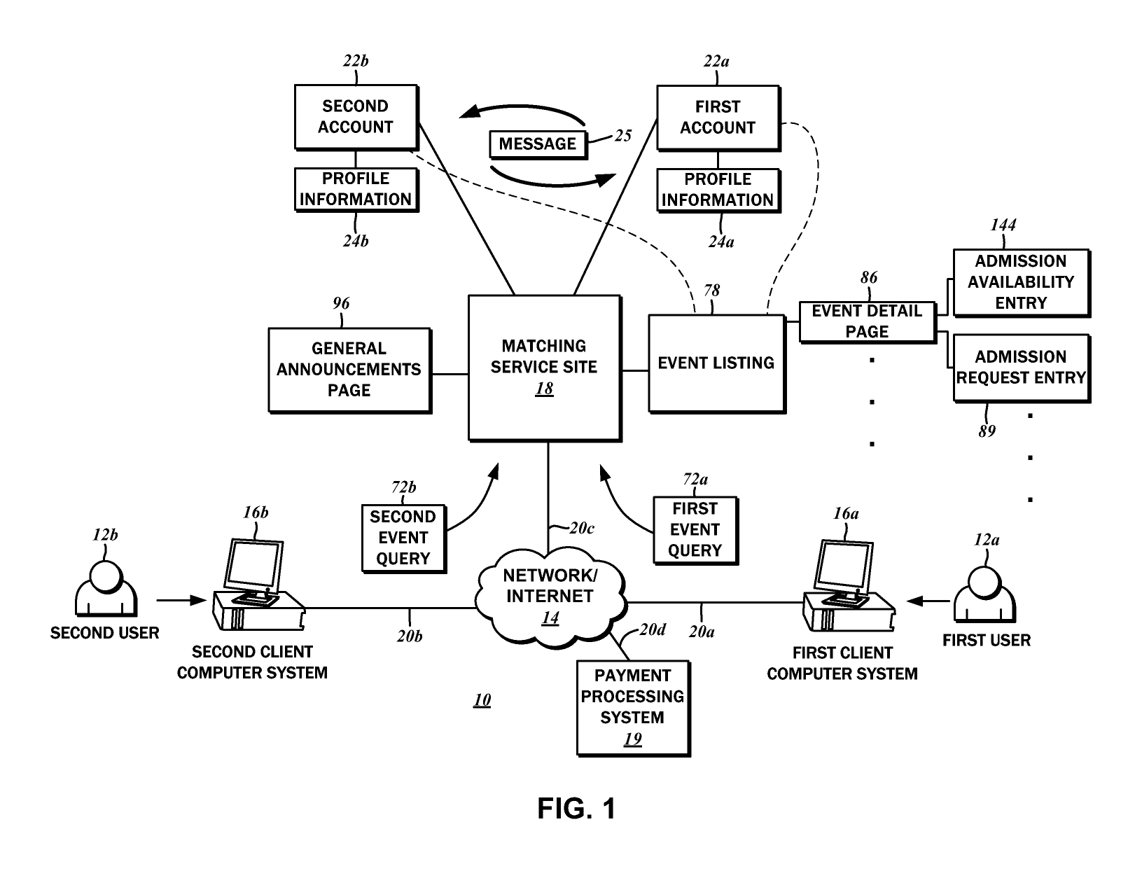

The block diagram of FIG. 1 illustrates an example networked computing environment 10 in which various embodiments of the present disclosure may be implemented. At the most basic level, methods that connect, in the broadest sense, a first user 12a and a second user 12b are contemplated. One modality for so connecting the users 12 is a data communications network 14 that is accessed by respective first and second client computer systems 16a, 16b. The client computer systems 16 may be conventional personal computer devices including a central processing unit, memory, and various input and output devices such as keyboards, mice, and display units. However, the client computer systems 16 may be a mobile device such as a smart phone, a notebook computer, a tablet computing device, or any other suitable data processing apparatus. An intermediary system such as a matching service site 18 performs various steps of the contemplated methods in cooperation with the client computer systems 16 for connecting the first user 12a to a second user 12b. Some embodiments may utilize a third party payment processor system 19.

Preferably, though optionally, the network 14 is the Internet, and the two terms may be referenced interchangeably. However, it is understood to encompass any link over which data communications may proceed between the network nodes, including the client computer systems 16 and the matching service site 18. In particular, the first client computer system 16a has a first network link 20a to connect to the network 14, while the second client computer systems 16b has a second network link 20b. The matching service site 18 connects to the network 14 via a network link 20c, and the third party payment processor system 19 connects to the network 14 via a network link 20d. The network links 20 may be any suitable physical layer network connection that is capable of handling data traffic over a variety of protocols. The present disclosure will make general reference to data being exchanged amongst first client computer system 16a, the second client computer system 16b, and the matching service site 18. It will be recognized by those having ordinary skill in the art that such data exchanges proceeds according to those protocols and physical layer network connections, but the details thereof will not be provided. Any other suitable protocol or data link may be substituted without departing from the scope of the present disclosure.

The client computer systems 16 may each have executable instructions of a web browser application that are loaded thereon. The web browser application communicates with the matching service site 18 over the hypertext transfer protocol (HTTP), among other protocols known in the art. In this regard, the matching service site 18 may be a World Wide Web (Web) server that processes requests initiated from the client web browser applications, and transmits the requested data to the client computer systems 16. The requested data is typically Hypertext Markup Language (HTML) pages that are stored or dynamically generated by the matching service site 18. The server hardware upon which the matching service site 18 is implemented may include processors, memory, data storage devices, and network interface devices that are managed by an operating system and run web application servers. Various scripts may also be executed by the web application servers to implement the contemplated methods of the present disclosure. Upon receipt of the HTML pages, the client web browser application renders the same on the respective client computer system 16 for display to the user 12. It is also contemplated that the communication may also be implemented through RSS (Really Simple Syndication) or another form of common information aggregation methods.

As indicated above, the various embodiments of the present disclosure contemplate a method for matching the first user 12a to the second user 12b with the matching service site 18. In order to facilitate interactions between the first user 12a and the second user 12b, each are understood to be assigned a user account 22. In particular, the first user 12a is assigned to a first user account 22a, while the second user 12b is assigned to a second user account 22b. Each of the user accounts 22 may be uniquely identified by an account name, an account identification number, or an e-mail address, or any combination thereof. In order to gain access to the user account 22, a password may be required, and may accordingly be stored on the matching service site 18. The user accounts 22 also have user profiles 24 associated therewith. In some implementations, the user account 22 and the user profile 24 may be stored in the same data structure, with the user profile 24 being part of the user account 22. Regardless of the specific formatting or structure, the user account 22 serves as a repository for biographical information of the corresponding user 12.

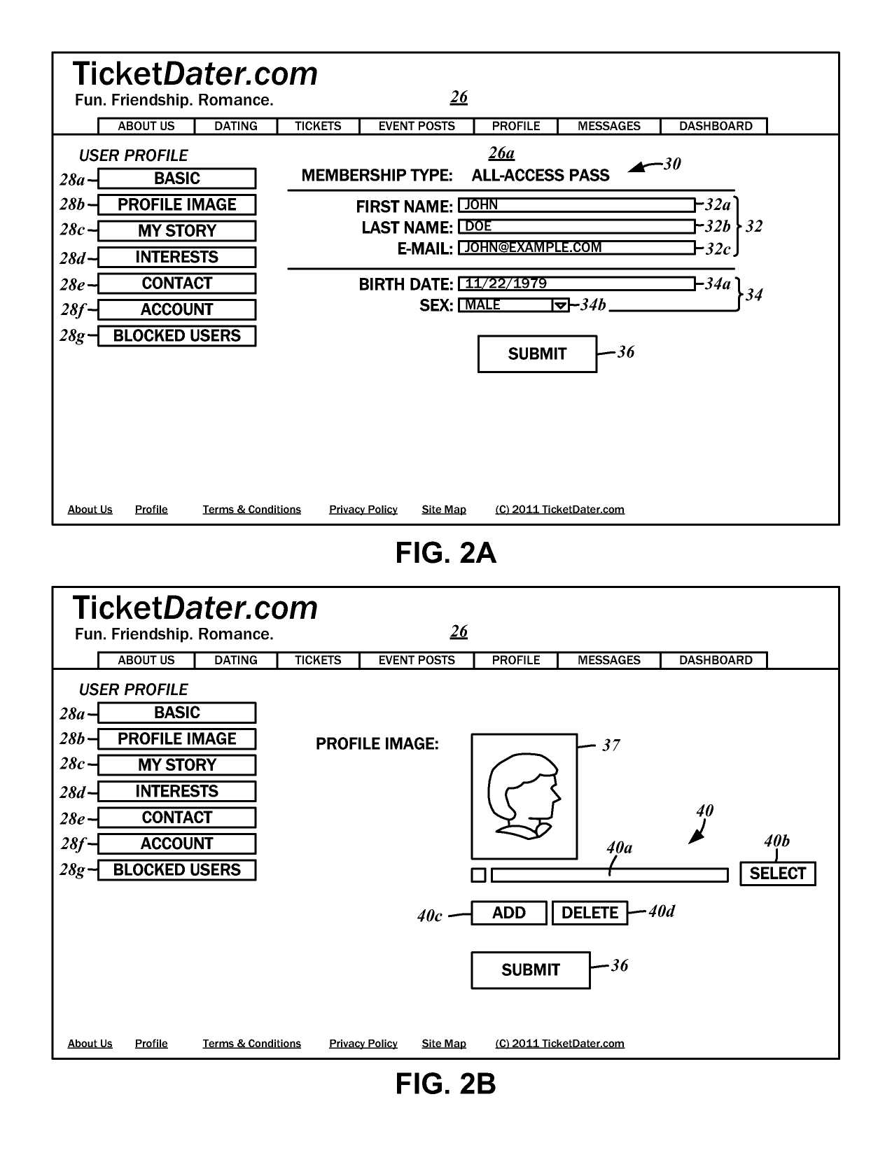

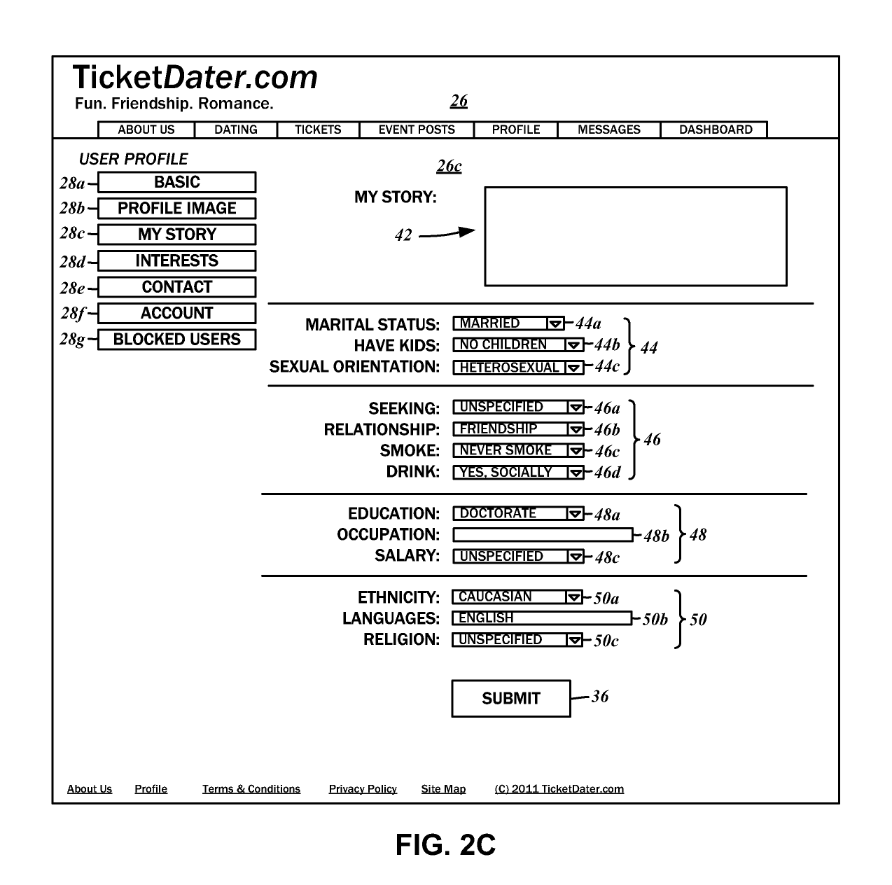

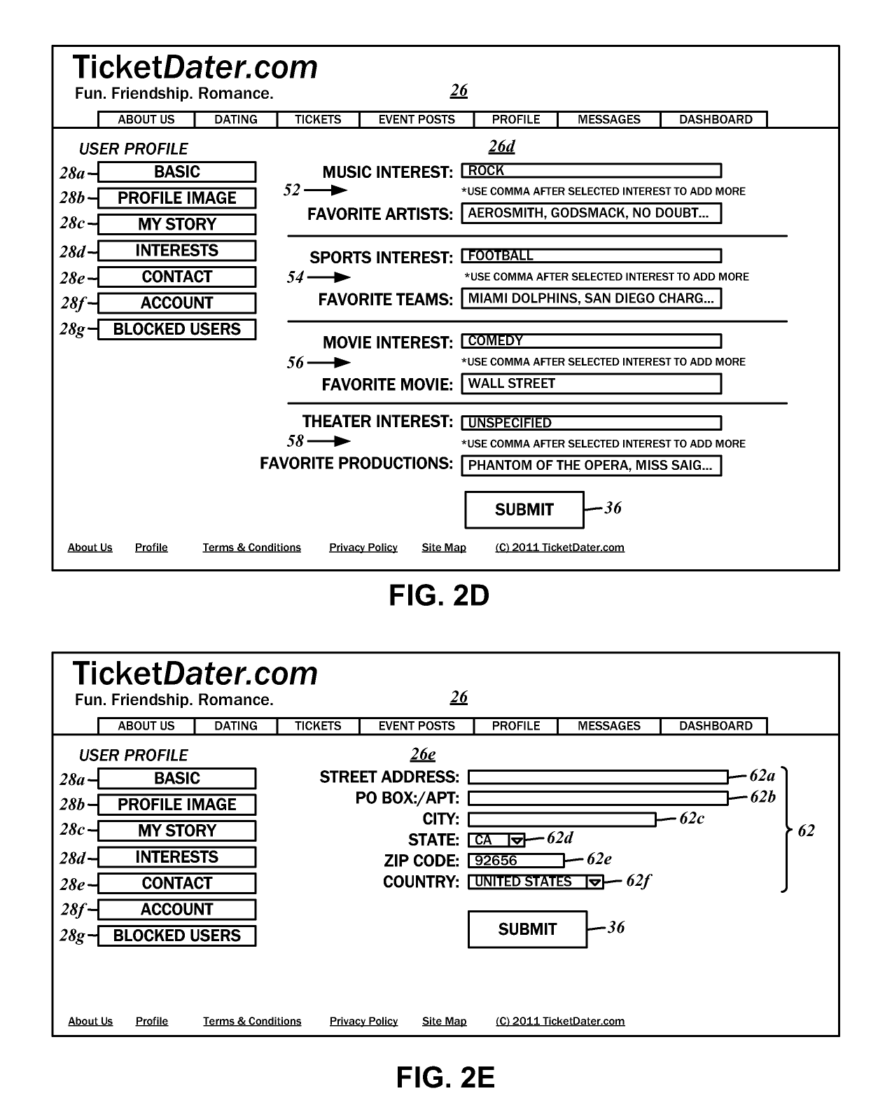

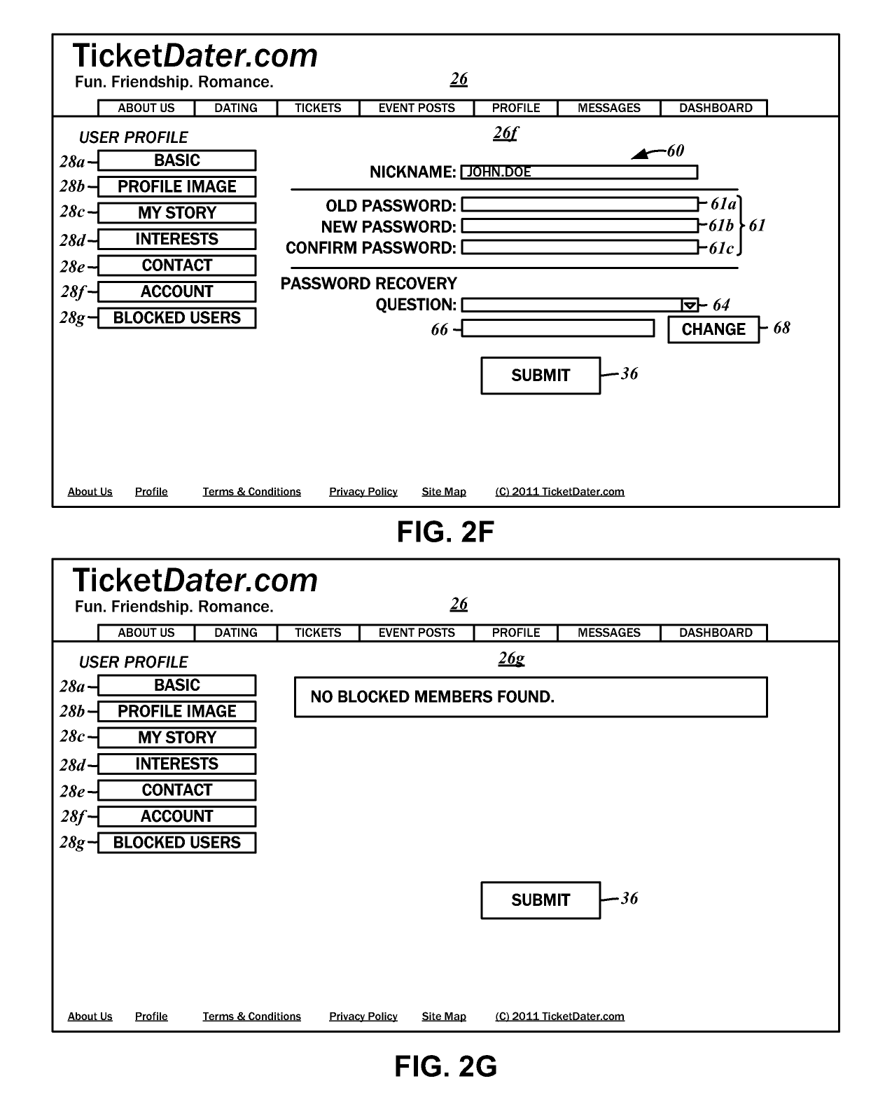

With reference to the screenshot of FIGS. 2A-2G, one exemplary embodiment of a user account and profile modification interface 26 will be described. This will also serve to illustrate the various types of biographical information collected from the user 12. It will be recognized by those having ordinary skill in the art that the user account and profile modification interface 26 may be implemented in a variety of different ways, and need not be limited to the specific arrangement shown herein.

Generally, the profile modification interface 26 is divided into seven separate tabs that are accessed via category buttons 28a-28g. One contemplated way to generate revenue to offset the cost of operating the matching service site 18 is to collect small fee from each of the users 12. Depending on how much is paid, the users 12 may be assigned a membership level that is used to set access limits to the matching service site 18. In a first tab 26a that can be accessed via the basic button 28a, this membership level is indicated on an account type section 30. The first tab 26a also includes a contact input section 32, including a first name input 32a, a last name input 32b, and an e-mail input 32c. Furthermore, there is a basic demographic input section 34 comprised of a birthdate input 34a and a gender input 34b. To the extent that any changes are made to the aforementioned fields, once made, a submit button 36 may be activated to upload the data to the matching service site 18. As will be recognized, upon initial input from the user 12 on the web browser application running on the client computer system 16, the data has not yet been transmitted to the matching service site 18.

Continuing to FIG. 2B, activating the profile image button 28b invokes a profile image tab 26b. If the user 12 has already uploaded a profile picture, the image is displayed in a thumbnail section 38. Otherwise, a placeholder image is shown therein. A file upload interface sub element 40 provides an input box 40a for specifying a local file path for the profile image to be uploaded. A file system navigator button 40b may be activated to invoke a visual interface to the local file system of the client computer system 16 that can be employed to locate the desired profile image. Once the file path is specified, an add button 40c may be activated to initiate the file transfer process. If any earlier uploaded profile image is no longer preferred, it may be deleted from the matching service site 18 upon activating a delete button 40d. After any changes, they may be committed to the matching service site 18 by activating the submit button 36. The profile image is understood to be associated with the user profile 24. Although the foregoing describes a process for uploading a single profile image, it is contemplated that the multiple images may be uploaded without departing from the spirit and scope of the present invention.

Further detailed personal information may be added and edited via a “my story” tab 26c, which can be accessed via a “my story” button 28b as shown in FIG. 2C. A narrative input section 42 accepts the entry of an extended text message that conveys to its audience certain personal information, as written by the user 12. In a basic personal information input section 44, the users 12 may specify a marital status 44a, a children status 44b, and sexual orientation status 44c. A personal preference input section 46, except entry of a preferred gender 46a, a preferred relationship type 46b, a smoking status 46c, and a drinking status 46d. In a personal background input section 48, an education level 48a, and occupation 48b, and a salary 48c may be specified. Furthermore, in a demographic input section 50, an ethnicity 50a, spoken languages 50b, and practice religion 50c may be specified. In accordance with one embodiment of the present disclosure, these various inputs may be specified via pulldown menus form elements comprised of limited selectable values, or via freeform text input forms. Those having ordinary skill in the art will recognize which types of information are better suited for one or the other type of form element. Again, any changes made in the “my story” tab 26c are committed to the matching service site 18 upon selecting the submit button 36. It is understood that the personal information listed above is exemplary in nature only and is not intended to limit the scope of the present invention. In this regard, additional personal/biographical information may also be used.

Referring now to FIG. 2D, there is shown an interests tab 26d accessed via an interests button 28d. The interests tab 26d is segregated into a musical interests section 52, a sports interests section 54, a movie interests section 56, and a theater interests section 58. For each of these sections, there is a general interests selection menu through which various broad categories of interests may be selected, as well as a detailed interests input box through which specific artists, teams, movies and productions may be indicated. Any changes made in the interest tab 26d are committed to the matching service site 18 after the submit button 36 is activated. It is understood that the interests listed above is exemplary in nature only and is not intended to limit the scope of the present invention. In this regard, additional interests may also be used.

FIG. 2E illustrates a contact input tab 26e that is accessed through a contact button 28e. In this portion, the mailing address 62 of the user 12 is specified, and includes a first address line 62a, a second address line 62b, a city line 62c, a state selection menu 62d, a zip code line 62e, and a country selection menu 62f. Again, changes made to any one of these values are saved to the matching service site 18 only after activating the submit button 36.

As indicated above, the user account 22 is associated with a particular user and is uniquely identified within the matching service site 18, with access thereto being limited with a password. The user account and profile modification interface 26 includes an account tab 26f that is accessed via the account button 28f, and includes a nickname section 60 for specifying the name associated with the user account 22 that is displayed to other users 12 when communicating over the matching service site 18. When changing the password, the user 12 is required to input the earlier password 61a, a new password 61b, and a re-entered new password 61c. In case the password is lost, a password recovery question may be set via a pull down menu 64, which lists several possible questions. The answer to the selection question may be input in a password recovery answer text input box 66. If it is desired to change only the password recovery question, a change button 68 may be activated. The submit button 36 is activated to change the password.

Given that the matching service site 18 may have numerous users 12, there may be some who are offensive, disturbing, or otherwise objectionable, and with whom a particular user desires to have no contact. In a blocked users tab 26g accessed via a blocked users button 28g, a list of users who to be ignored is shown. A given user's profile 24 is accessible via links on a number of different pages served by the matching service site 18, and may be blocked therefrom.

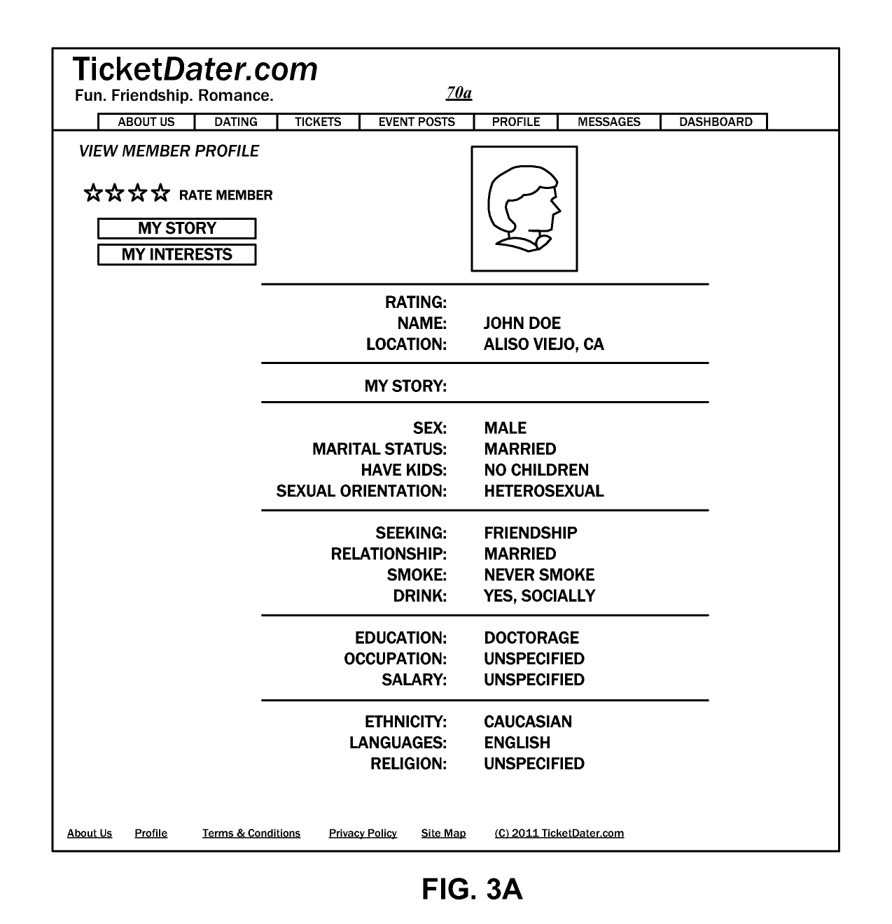

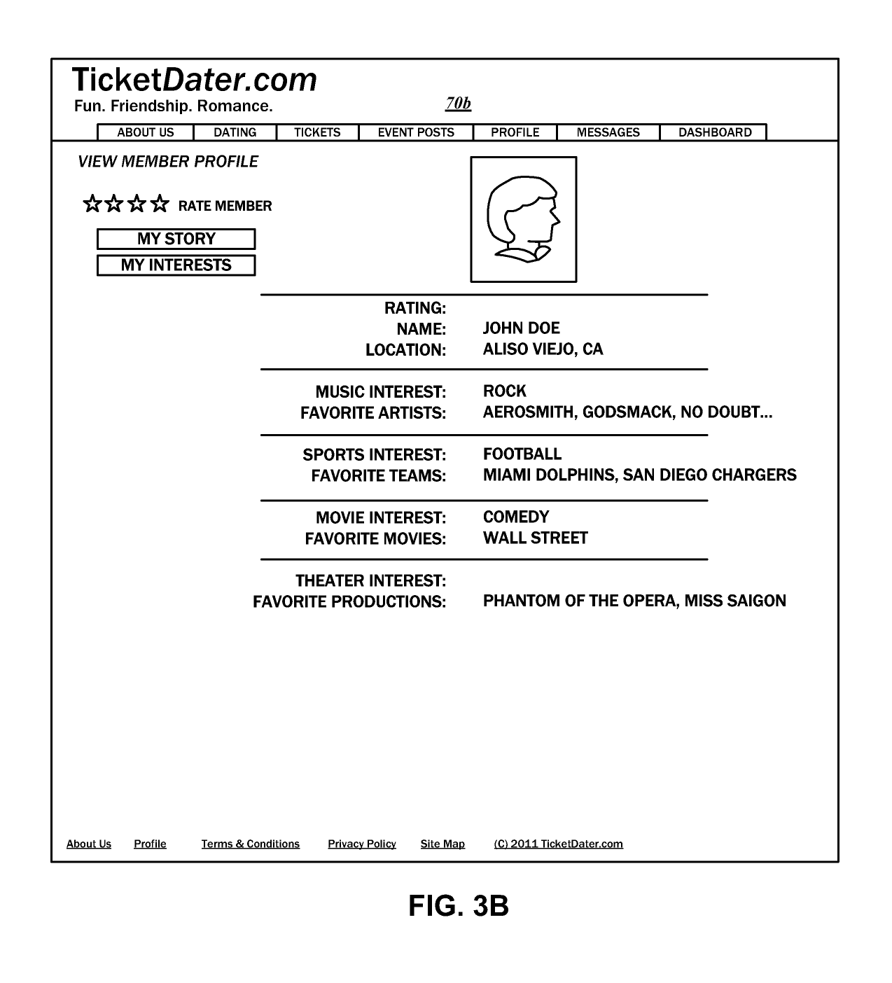

Once some or all of the foregoing information is provided to the matching service site 18, it is available for view by other users 12. With reference to the screenshot of FIGS. 3A and 3B, an exemplary implementation of a profile page 70 shows the data separated into a “my story” segment 70a and a “my interest” segment 70b. It will be appreciated that the visual form of the profile page 70 may be varied from that shown in FIGS. 3A and 3B, and different privacy settings are possible to show or hide certain information. Furthermore, the forgoing enumeration of profile information that is requested and displayed through the matching service site 18, is intended to be by way of example only and not of limitation. More or less information may be requested and displayed.

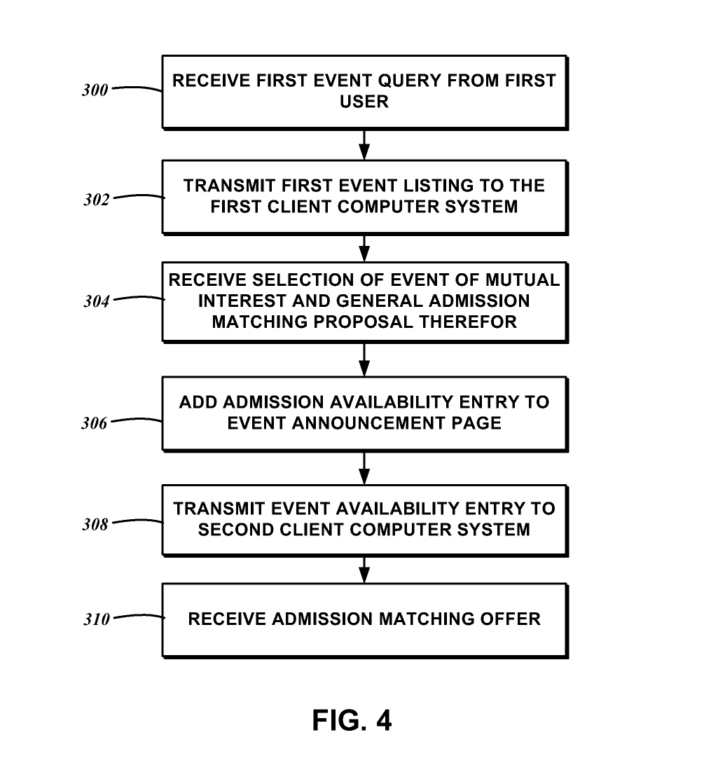

The flowchart of FIG. 4 depicts one embodiment of the presently contemplated method for matching the first user 12a to the second user 12b. It is envisioned that the matching service site 18 facilitates the joint attendance of an event of mutual interest between the first user 12a and the second user 12b. As utilized herein, an event may be a sporting event, a music event such as a concert, a movie, a theater production, or any other entertainment event which the users 12 may desire to attend.

The method begins with a step 300 of receiving a first event query 72 from the first user 12a. In further detail, the first event query 72 is transmitted from the first client computer system 16a as part of a submission relating to an initial event search page 74 that is rendered by its web browser application. This may be preceded by the matching service site 18 transmitting the initial event search page 74 to the first client computer system 16a upon initial login. The initial event search page 74 has an event name input element 74a, an event location input element 74b, and an event date input element 74c, which can be utilized to further narrow the scope of the first event query by the limits indicated therein. Without inputting values in the initial event search page 74 and simply activating a search button 76 a query for events stored on the matching service site 18 is made.

There is an event listing/database 78 that is a part of or connected to the matching service site 18. It is understood that the event listing 78 contains each of the aforementioned entertainment events that may be of interest to the users 12. The source of this data may be external ticket agent websites with which the matching service site 18 has some affiliate relationship, or manually or programmatically entered from local event calendars, and so forth. As shown in the diagram of FIG. 6, the event listing 78 is comprised of event entries 80 defined by an event date 80a, an event time 80b, an event name 80c, an event city 80d, and an event venue 80e.

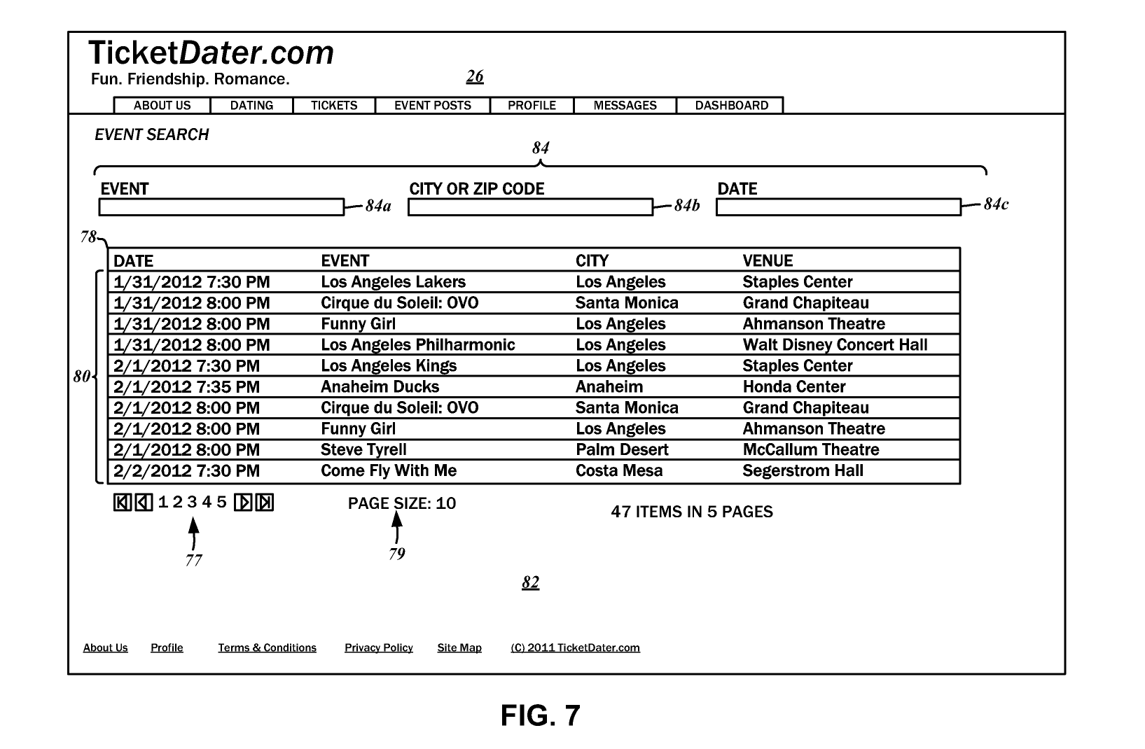

The method may continue with a step 302 of transmitting the first event listing 78 from the matching service site 18 to the first client computer system 16a. In accordance with one embodiment of the present disclosure, the first event listing 78 is incorporated into a query results page 82, an example of which is shown in the screenshot of FIG. 7. The first event listing 78 is understood to conform to the first event query 72, that is, only the event entries 80 that match the specified criteria from the initial event search page 74 are returned to the first client computer system 16a. If no criteria were indicated as part of the first event query, then all of the event entries 80 in the first event listing 78 are returned. The first event listing 78 may be separated into multiple pages, and accordingly includes a page navigation interface element 77. It is possible to define the number of event entries 80 shown in one page via a page size input element 79.

The contents of the first event listing 78 may be narrowed further even after the query results page 82 is transmitted to the first client computer system 16a. The query results page 82 includes several query narrowing input elements 84 including an event name input element 84a, an event location input element 84b, and an event date input element 84c. Upon entering criteria in the query narrowing input elements 84, the first event listing 78 may be re-generated with only the event entries 80 matching such criteria. For example, in the example shown in FIG. 7, if a narrowing criteria of “Los Angeles” is entered, only those event entries 80 with a city of “Los Angeles” is shown; all others such as those taking place in Santa Monica, Anaheim, and so forth, are removed. As those having ordinary skill in the art will appreciate, this regeneration process may occur client side, or occur after a form submission to the matching service site 18.

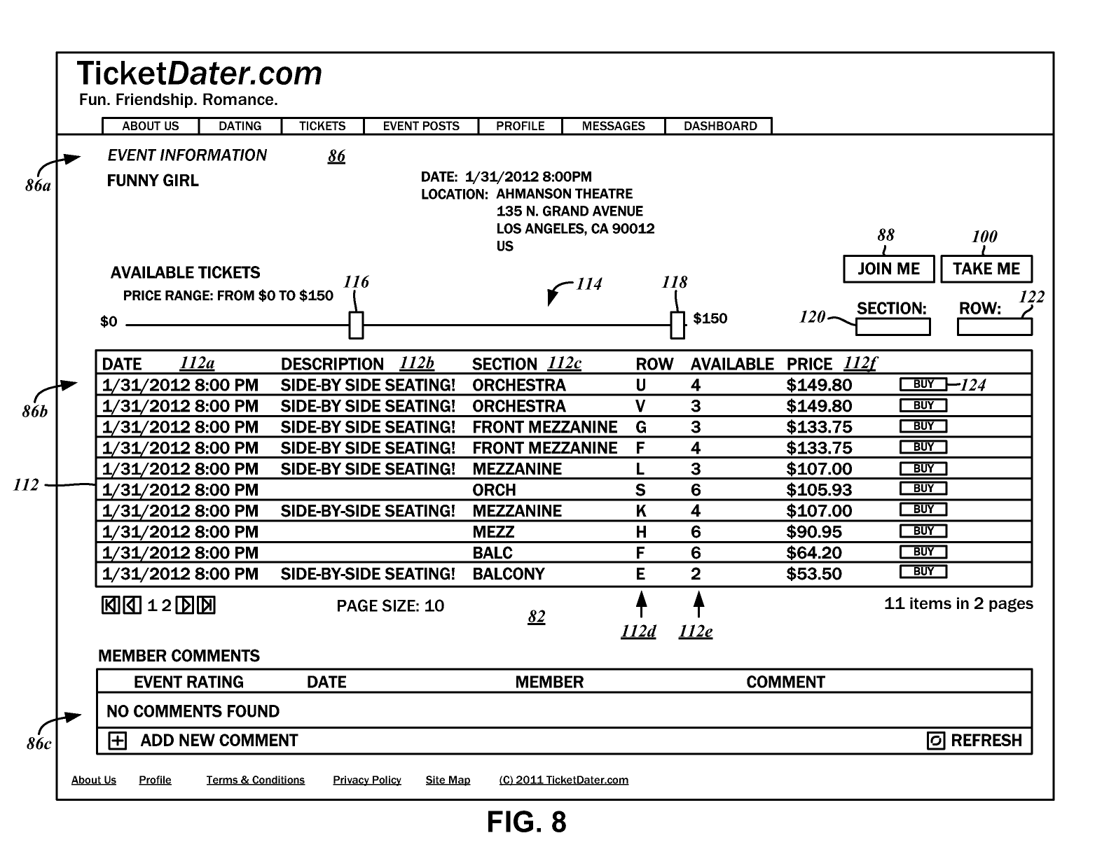

Amongst the event entries 80 in the first event listing 78 there is an event of interest to the first user 12a, and possibly of interest to the second user 12b (as of yet unknown). The event entries 80 may include hyperlinks to respective event detail pages 86, the selection by the first user 12a of which is operative to initiate a request to the matching service site 18 for the corresponding event detail page 86. The counterpart in the method for matching the first user 12a to the second user 12b may be a step 304 of receiving the selection of the desired event. The event detail page 86 as shown in FIG. 8 is then transmitted to the first client computer system 16a. Under an event information heading 86a, the name of the event is indicated, along with the date, time, and location. In an available tickets or admissions section 86b, there is a listing of tickets for the event that may be purchased, the details of which will be expanded upon more fully below. There is also a member comments section 86c where general messages regarding the event itself may be posted by the users 12 for sharing with all other users also viewing the event detail page 86.

It is expressly contemplated that the step 304 includes receipt of a general admission matching proposal for the selected event. One of the interactive elements of the event detail page 86 is an inviter (“Join Me”) button 88, which is intended as a way for the first user 12 to extend a general invitation for another user to join in attendance of the selected event. As utilized herein, the term admission refers to tickets, coupons, cards, tokens, and the like that grant access to an event, regardless of whether such items are electronic or have a physical manifestation. To the extent no actual tokens exist that signify the granted access, the term admission is also understood to encompass pre-existing obligations to allow entry of individuals to an event/venue based on their identity, affiliation, or otherwise. Although in one embodiment the receipt of the general admission matching proposal and the event selection appear to be two separate steps, where the inviter button 88 is used to initiate the transmission of the general admission matching proposal, by its nature the selection of the event is also being transmitted as part of a single step in the method. Either combined as a single step in this manner or separated, both are intended to be encompassed within the scope of the present disclosure.

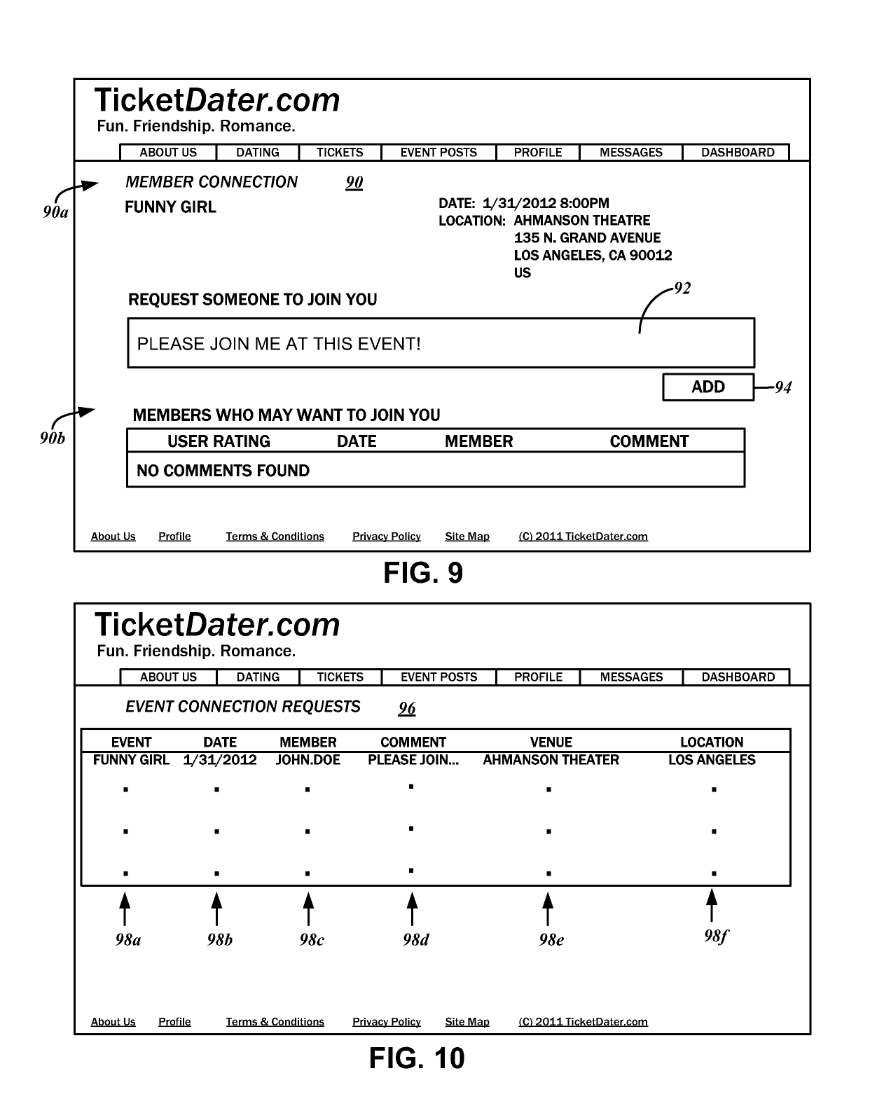

The method continues with a step 306 of adding to or otherwise storing in association with the event detail page 86 an admission availability entry 89 that corresponds to the general admission matching proposal. Additional user-generated content may be added as part of the admission availability entry 89, and the screenshot of FIG. 9 illustrates one exemplary invitation input page 90. The same information as provided under the event information heading 86a of the event detail page 86 is shown under a corresponding event information heading 90a of the invitation input page 90, including the name of the event, the date of the event, and the location of the event. Additionally, there is a free-form text message input box 92 through which further details of the general invitation may be provided. Upon activating an add button 94, the message 25 is uploaded to the matching service site 18 and stored for subsequent access through the event detail page 86. Any messages posted thereby are automatically associated with the author, which in this case is the first user 12a. Essentially, the message 25 serves as a modality of connecting one user 12 to another. It is understood, however, that the messages 25 may be exchanged independently of the admission availability entry 89, such as through mutual interests generated via the profile information 24a.

It is also possible for users 12 to request invitations to the event. To the extent any such requests have been made, a request notification section 90b lists the requesting users 12. The manner in which the requests are added will be explained more fully below. If the second user 12b had already posted an admission request entry, that may be displayed in the invitation input page 90, and there may not be a need for the first user 12a to post the admission availability entry 89.

Besides adding the admission availability entry 89 to the event detail page 86, it is also contemplated that a general announcement not limited to the specific selected event can also be made. An example general announcement page 96 is illustrated in FIG. 10, and in addition to the information about the first user 12a posting the invitation, details pertaining to the selected event are also posted. In this regard, there is a first column 98a showing the name of the event, a second column 98b showing the date of the event, a third column 98c showing the particular user 12 who posted the invitation, a fourth column 98d showing the additional message added via the invitation input page 90 as discussed above, a fifth column 98e showing the venue of the event, and a sixth column 98f showing the location or specific address of the event.

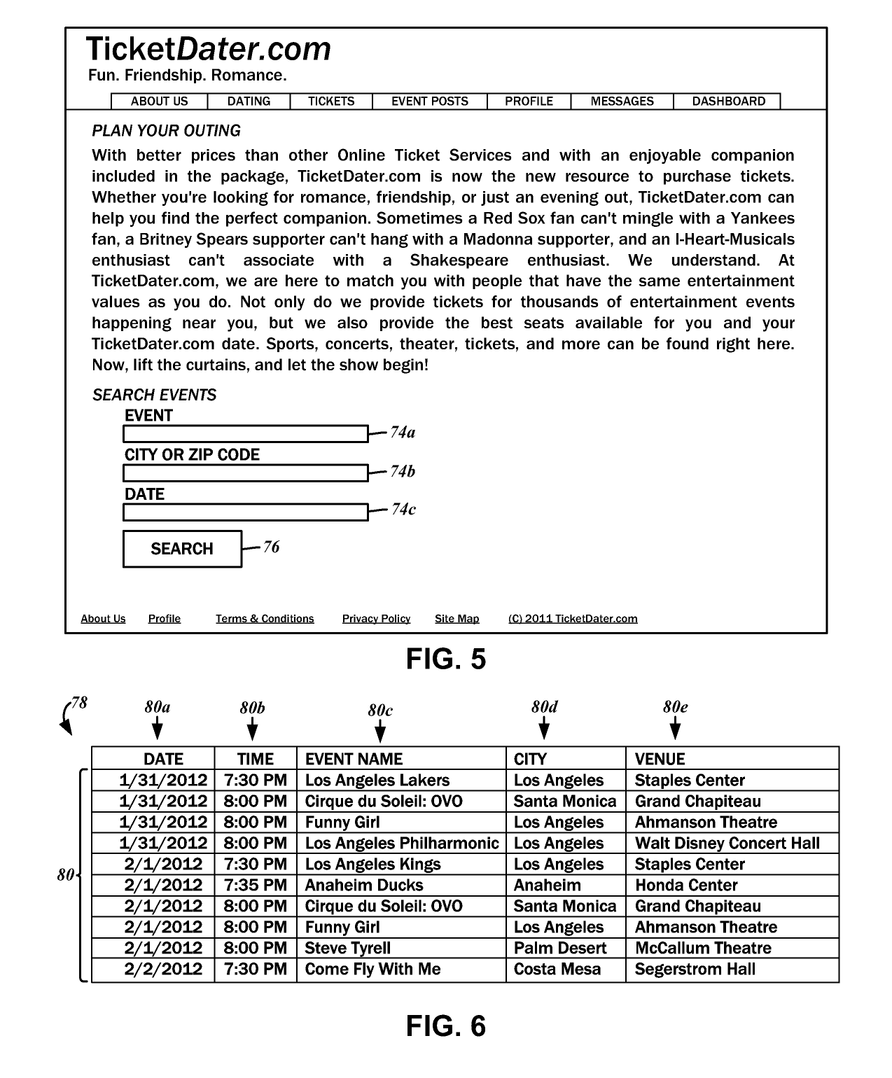

Having considered the details of how an invitation to an event is posted to the matching service site 18, the steps involved in accepting the invitation by the second user 12b will now be considered. The events available to the second user 12b are the same set included in the above-described event listing 78. Accordingly, another second query 72b is made thereto in order to retrieve the same data. This second event query 72b is initiated through the same interface of the initial event search page 74 shown in FIG. 5, and continues with same interface of the query results page 84 shown in FIG. 7, except that a second version of the event listing 78 is rendered on the second client computer system 16b. Through this interface, a desired event may be selected in the same way as discussed above with reference to FIG. 7, and is operative to request the same event detail page 86 shown in FIG. 8.

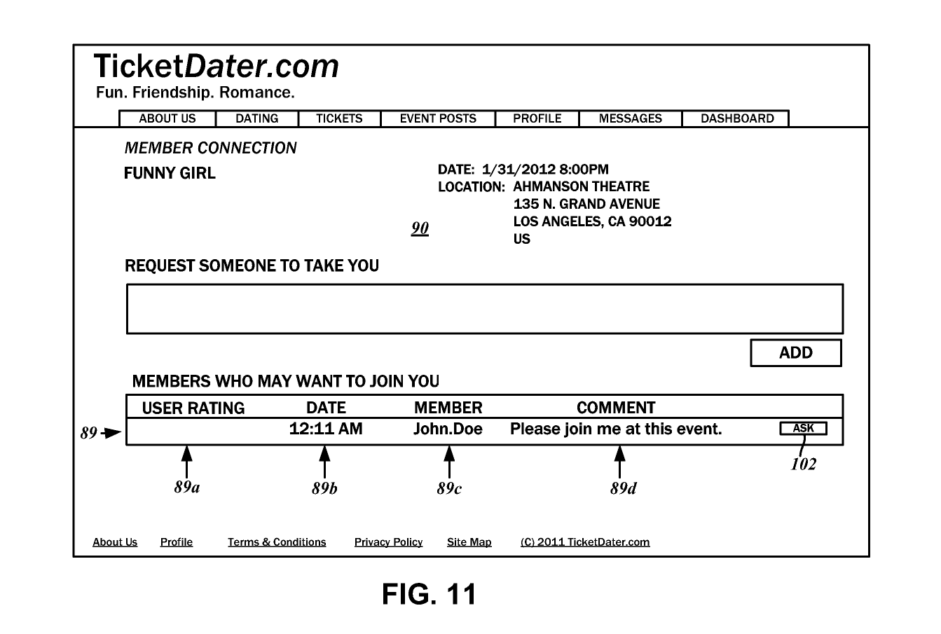

Instead of activating the inviter (“Join Me”) button 88, because the second user 12b desires to be invited to the event, an invitee (“Take Me”) button 100 is activated. Referring again to the flowchart of FIG. 4, this initiates the transmitting of the admission availability entry 89 to the second client computer system 16b according to a step 308. Incidental to the admission availability entry 89 is an invitation input page 90 as shown in FIG. 11. The admission availability entry 89 may include a user rating 89a, an entry date 89b, a member identifier 89c that is the specified nickname associated with the author, the first user 12a, and a comment 89d that corresponds to the text inputted by the first user 12a in the free-form text input box 92 of the invitation input page 90. The member identifier 89c may include a link to the profile 24a of the first user 12a, where the second user 12b can briefly ascertain whether the first user 12a would make a suitable companion for attending the event of mutual interest. If so, an ask button 102 can be activated to respond to the general invitation from the first user 12a. The ask button 102 may also be associated with existing admission request entries that are displayed on the invitation input page 90.

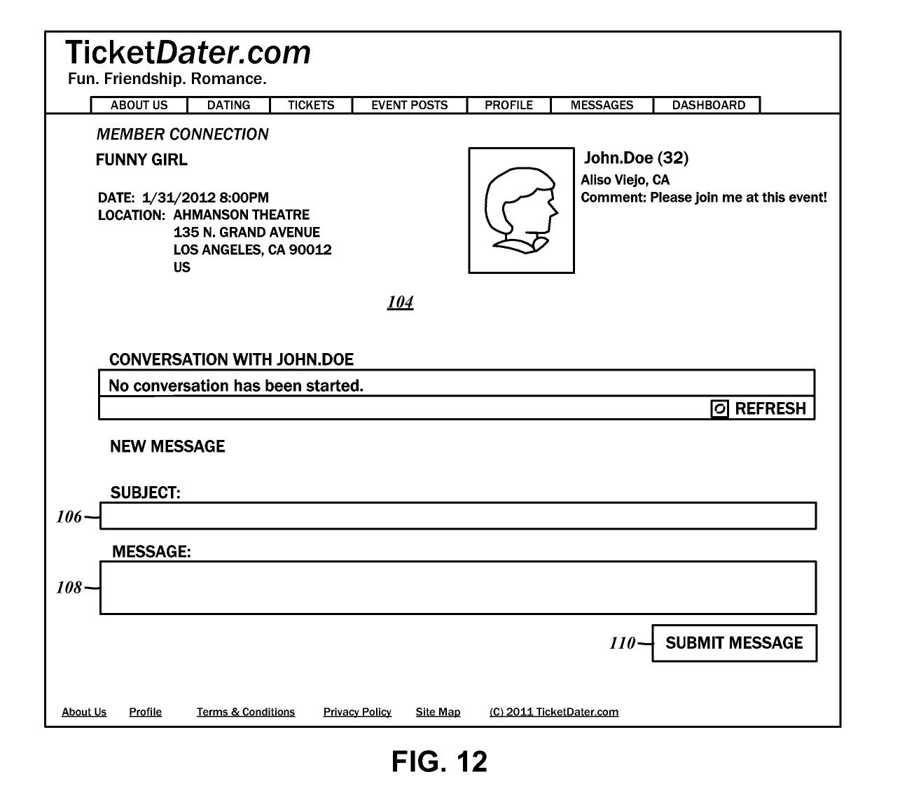

Referring to the screen shot of FIG. 12, a connection request page 104 is transmitted to the second client computer system 16b. This includes the basic information for the selected event, as well as basic information concerning the inviting user, which in this example is the first user 12a. With the connection request page 104, the second user 12b can initiate an admission matching offer to the first user 12a. The counterpart step as performed on the matching service site 18 is a step 310 of receiving the admission matching offer. The connection request page 104 includes a subject text input box 106, and a message text input box 108. In addition to the basic information needed to reference the particular event of mutual interest, the second user 12b may include introductory comments that go beyond what is provided in the profile 24b. Once the desired text is inputted, a message submission button 110 may be activated to send a message through the matching service site 18.

The reason that this message is deemed to be an offer is that the first user 12a still has the option of refusing to attend the event with the second user 12b. Based upon this message, however, a dialogue is initiated, and if the conversation proceeds to a point where the plans for the event of mutual interest are finalized, the first user 12a and the second user 12b have thus informally agreed to jointly attend.

The foregoing steps of the method presuppose that the first user 12a already has possession of the admission or tickets to the selected event. Various embodiments of the present disclosure also contemplate an option where the admissions can be purchased through the matching service site 18 at any time during the matching process. The earliest possible point is even before making the general invitation, when the first user 12a is interacting with the event detail page 86. The first user 12a, as the inviter, can also purchase the admissions after joint attendance had been decided with the second user 12b.

Referring back to the screen shot of FIG. 8, the available tickets or admissions section 86b includes a listing of admissions for the selected event. Each entry 112 includes an event date 112a, an admission description 112b, a seating section 112c, a seating row 112d, a quantity available indicator 112e, and a price 112f. It is understood that most events have assigned seating, and every admission or ticket is for a particular seat and is identified at least by the seating section 112c and the seating row 112d, in addition to the specific seat number within that row. The price 112f is adjusted based upon the location of the seat in the venue and its relation to the stage or other performance area, with more desirable front-row center seats fetching a premium for its proximity to the performance.

In deciding which admissions to purchase, it is also contemplated that a filter may be applied to its display in the available admissions section 86b. One filter condition or admission criterion is the price 112f, and there is a slider interface that specifies a price between $0 and the absolute maximum price among all listed admissions. A relative minimum may be set by a lower slider 116, while a relative maximum may be set by an upper slider 118. Only those admissions falling within the relative minimum and the relative maximum can be displayed in the available admissions listing, thereby narrowing the listing. Another filter condition or admission criteria is the seating location, as defined by the seating section 112c and the seating row 112d. These filter conditions may be specified in a section input box 120 and a row input box 122. As with the other user interface elements described above, as soon as anyone of the filter conditions are applied the results are reflected in the available admissions section 86b.

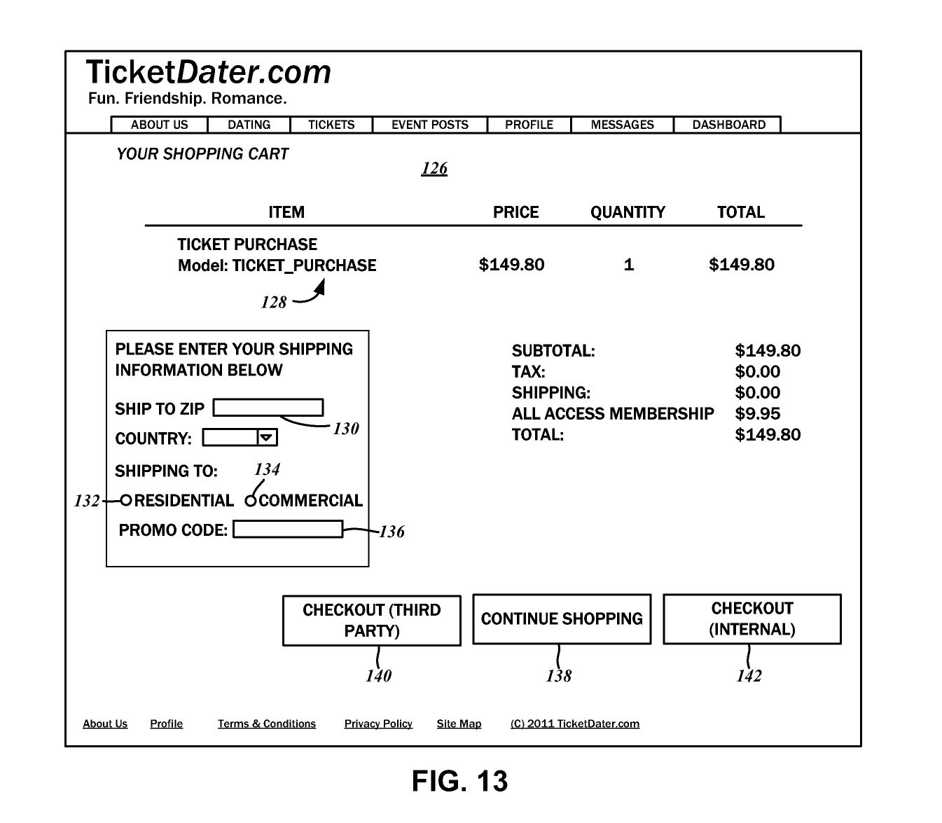

Each entry 112 also includes a buy link 124 to add that particular admission to a shopping cart for fulfillment. Referring to FIG. 13, an order fulfillment page 126 includes a listing 128 of the admissions that have been added to the shopping cart, and calculates subtotals based on the price 112f of the admissions, additional taxes and shipping fees, and so forth. More detailed estimates of the shipping cost may be generated upon the user 12 providing a shipping zip code via an input box 130, and selecting between a residential address with a first radio button 132 and a commercial address with a second radio button 134. It is common practice for online retailers to offer discounts by accepting promotional codes, and these may be submitted through an input box 136. The user 12 has the option to add more admissions to the cart for purchase via the continue shopping button 138. If there are no further admissions to add, payment may be finalized through one of two ways—via a third party payment processor 19 by selecting an external checkout button 140, or via an internal payment processing system by selecting and internal checkout button 142. Those having ordinary skill in the art will appreciate the various issues and set up considerations associated with payment processing, and so those details will not be discussed herein.

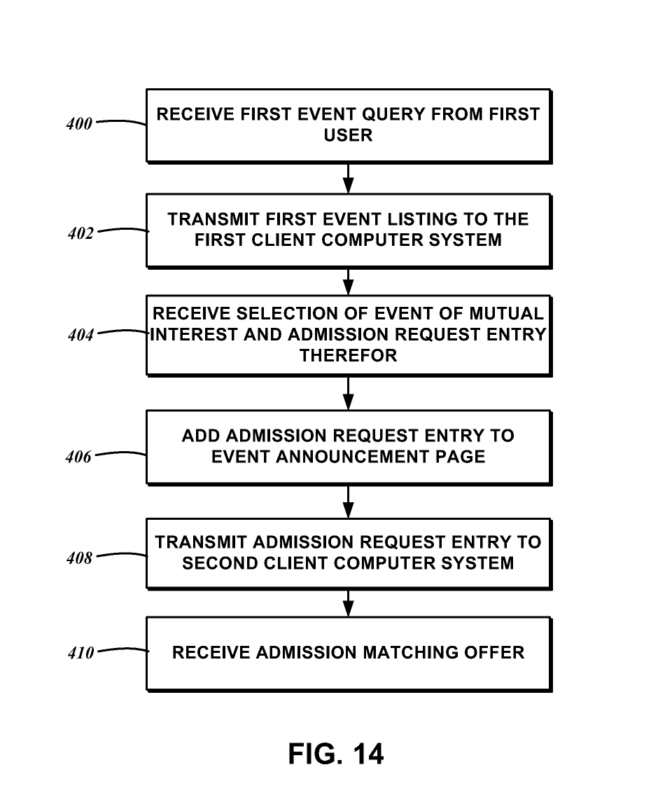

Another method for matching the first user 12a to the second user 12b for jointly attending an event of mutual interest is contemplated. This method is best illustrated in the flowchart of FIG. 14. Other embodiments involved the first user 12a making a general blanket invitation and an indication that admissions are available, followed by the second user 12b requesting that the invitation be specifically extended thereto, which can be likened to making an offer. This embodiment contemplates the first user 12a making a general request for an invitation from the other users 12, followed by the second user 12b making an offer to the first user 12a to see if there is any interest in jointly attending the event of mutual interest.

The first two steps of this method are understood to be the same as the first two steps 300, 302 of the first embodiment of the method for matching the first user 12a to the second user 12b, and understood to involve the same user interfaces of the initial event search page 74 shown in FIG. 5, the query results page 82 shown in FIG. 6, and the event detail page 86 shown in FIG. 7. In this regard, the method includes a step 400 of receiving the first event query 72 from the first user 12a, and a second step 402 of transmitting the first event listing 78 to the first client computer system 16a. The various user interface features of narrowing event listings 78 and the like are also understood to be applicable here.

Rather than selecting the inviter button 88, the invitee button 100 is. As with the step 304, step 404 includes receiving a selection of the event of mutual interest, but now an admission matching request is also received. This admission matching request is understood to be an announcement to potential companions for the event of mutual interest who may have acquired the admissions or tickets thereto and is looking to take someone else, or who has not yet acquired tickets but expects to do so in anticipation of taking someone else.

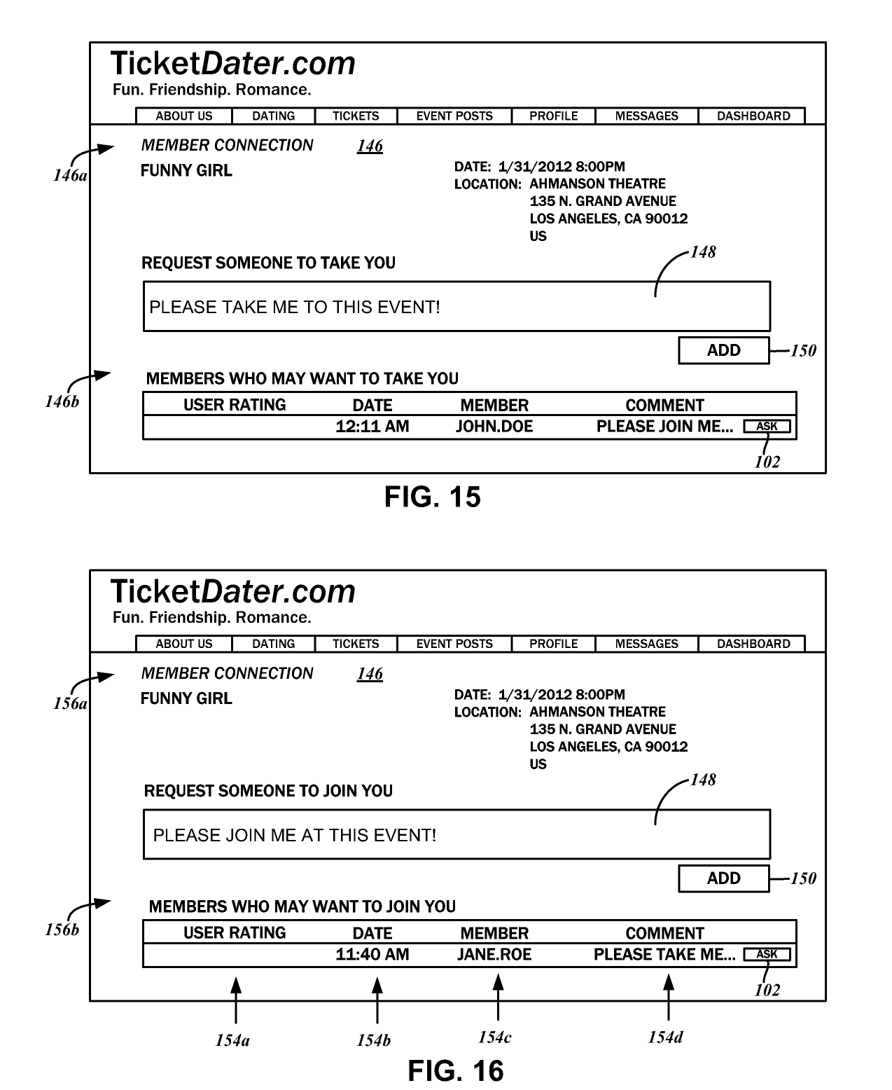

The method continues with a step 406 of adding to or otherwise storing in association with the event detail page 86 an admission request entry 144 that corresponds to the admission matching request. Again, additional user-generated content may be added as part of the admission request entry 144, and the screenshot of FIG. 15 illustrates another exemplary request input page 146. The same information as provided under the event information heading 86a of the event detail page 86 is shown under a corresponding event information heading 146a, including the name of the event, the date of the event, and the location of the event. Additionally, there is a free-form text message input box 148 through which further details of the request may be provided. Upon activating an add button 150, the message is uploaded to the matching service site 18 and stored for subsequent access through the event detail page 86. Any messages posted thereby are automatically associated with the author, which in this case is the first user 12a. Like the admission availability entry 89, the admission request entry 144 can be added to the general announcement page 96 shown in FIG. 10, with the same information but relating to the selected event being shown.

As indicated above, it is also possible for users 12 to make offers for invitations to the event. To the extent any such requests have been made, an invitation notification section 146b lists the inviting users 12. Continuing with the previous example, a user had already posted the admission availability entry 89, and the corresponding ask button 102 may be activated to respond to the invitation announcement. This can be accomplished via the connection request page 104 shown in FIG. 12.

The steps involved for the second user 12b to respond to the invitation request will now be considered. The events available to the second user 12b are the same set included in the above-described event listing 78, and another second event query 72b is made thereto in order to retrieve the data. This second event query 72b is initiated through the same interface of the initial event search page 74 shown in FIG. 5, and continues with same interface of the query results page 84 shown in FIG. 7, except that a second version of the event listing 78 is rendered on the second client computer system 16b. Through this interface, a desired event may be selected in the same way as discussed above with reference to FIG. 7, and is operative to request the same event detail page 86 shown in FIG. 8.

The second user 12b is desirous of inviting another user 12 to the selected event, and selects the inviter “Join Me” button 88. Referring again to the flowchart of FIG. 4, this initiates the transmitting of the request response page 156 and specifically the admission request entry 154 to the second client computer system 16b according to a step 408. Now, as shown in FIG. 16, the admission request entry 154 may include a user rating 154a, an entry date 154b, a member identifier 154c that is the specified nickname associated with the author, the first user 12a, and a comment 154d that corresponds to the text inputted by the first user 12a in the free-form text input box 148 of the request input page 146 shown in FIG. 15. The member identifier 154c may include a link to the profile 24a of the first user 12a, where the second user 12b can briefly ascertain whether the first user 12a would make a suitable companion for attending the event of mutual interest. If so, the ask button 102 can be activated to respond to the admission request entry 144 from the first user 12a.

Referring again to the screen shot of FIG. 12 the same connection request page 104 is transmitted to the second client computer system 16b. This includes the basic information for the selected event, as well as basic information concerning the inviting user, which in this example is the first user 12a. With the connection request page 104, the second user 12b can initiate the admission matching offer to the first user 12a. The counterpart step as performed on the matching service site 18 is a step 410 of receiving the admission matching offer. This message is also deemed to be an offer because the first user 12a has the option of refusing to attend the event with the second user 12b. A dialogue is initiated between the first user 12a and the second user 12b at this point, and if the conversation proceeds to finalizing the plans for the event of mutual interest, the first user 12a and the second user 12b have thus informally agreed to jointly attend.

It is understood that most events have a temporal element which causes the event to have a certain life cycle. Events reaching the end of their life cycle may be blocked from viewing by users and any matching requests attached to the events may also be blocked. However, two users who have message each other directly may still be able to communicate after the termination of the event.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for matching a first user of an online service site to a second user for jointly attending an event of mutual interest, the method comprising:
receiving a first event query from the first user;
transmitting, from the online service site to a first computer system of the first user, in response to and in conformance with the first event query, a first event listing of a plurality of selectable events including the event of mutual interest;
receiving from the first user a selection of the event of mutual interest and a general admission matching proposal therefor;
adding an admission availability entry to an event announcement page associated with the selected event of mutual interest, the admission availability entry corresponding to the general admission matching proposal;
transmitting the admission availability entry from the online service site to a second computer system of the second user of the online service; and
receiving from the second computer system an admission matching offer for the event of mutual interest in response to the general admission matching proposal therefor.

2. The method of claim 1, wherein:
the admission availability entry includes a text message from the first user; and
the admission matching offer includes another text message from the second user.

3. The method of claim 1, where the admission availability entry includes a link to a profile page associated with the first user, the profile page including biographical detail elements of the first user.

4. The method of claim 1, further comprising:
receiving a second event query from the second user; and
transmitting, from the online service site to the second computer system, in response to the second event query, a second event listing of a plurality of selectable events including the event of mutual interest.

5. The method of claim 1, further comprising:
adding the admission availability entry to a general announcement page including other admission availability entries from other users.

6. The method of claim 1, further comprising:
generating a listing of admissions to the selected event of mutual interest available for purchase.

7. The method of claim 6, further comprising:
receiving payment from the first user for a set of the admissions to the selected event of mutual interest, the first set of admissions being defined by a price and a venue seating location.

8. The method of claim 6, further comprising:
narrowing the listing of the admissions based on at least one admission criterion.

9. The method of claim 8, wherein the at least one admission criterion is a price of the admission.

10. The method claim 8, wherein the at least one admission criterion is a venue seating location.

11. The method of claim 1, further comprising:
narrowing the listing of the plurality of selectable events based on at least one event criterion.

12. The method of claim 11, wherein the at least one event criterion is a venue location of the event.

13. The method of claim 11, wherein the at least one event criterion is a name of the event.

14. The method of claim 11, wherein the at least one event criterion is a date of the event.

15. A method for matching a first user of an online service site to a second user for jointly attending an event of mutual interest, the method comprising:
receiving a first event query from the first user;
transmitting, from the online service site to a first computer system of the first user, in response to and in conformance with the first event query, a first event listing of a plurality of selectable events including the event of mutual interest;
receiving from the first user a selection of the event of mutual interest and an admission matching request therefor;
adding an admission request entry to an event announcement page associated with the selected event of mutual interest, the admission request entry corresponding to the admission matching request;
transmitting the admission request entry from the online service site to a second computer system of the second user of the online service; and
receiving from the second computer system an admission matching offer for the event of mutual interest in response to the admission matching request therefor.

16. The method of claim 15, wherein:
the admission request entry includes a text message from the first user; and
the admission matching offer includes another text message from the second user.

17. The method of claim 15, where the admission request entry includes a link to a profile page associated with the first user, the profile page including biographical detail elements of the first user.

18. The method of claim 15, further comprising:
receiving a second event query from the second user; and
transmitting, from the online service site to the second computer system, in response to the second event query, a second event listing of a plurality of selectable events including the event of mutual interest.

19. The method of claim 15, further comprising:
adding the admission request entry to a general announcement page including other admission request entries from other users.

20. The method of claim 15, further comprising:
narrowing the listing of the plurality of selectable events based on at least one event criterion.

21. The method of claim 20, wherein the at least one event criterion is a venue location of the event.

22. The method of claim 20, wherein the at least one event criterion is a name of the event.

23. The method of claim 20, wherein the at least one event criterion is a date of the event.
